(19) United States
(12) Patent Application Publication
(10) Pub. No.: US 2026/0236598 A1
(43) Pub. Date: Aug. 13, 2026

(54) AUTHENTICATION OF DATABASE SERVICES

(71) Applicant: Honeywell International Inc., Charlotte, NC (US)

(72) Inventors: Karthikeyan M, Madurai (IN); Gobinathan Baladhandapani, Madurai (IN)

(21) Appl. No.: 19/180,152

(22) Filed: Apr. 16, 2025

(30) Foreign Application Priority Data
Feb. 13, 2025 (IN) 202511012384

(51) Int. Cl. G06F 21/62; G06F 16/95

(52) U.S. Cl. CPC G06F 21/6218; G06F 16/95

(57) ABSTRACT

Approaches for authentication of navigation databases are provided. In one example, a token request may be received over a communication network. The token request may be generated in response to processing a machine-readable code presented on an interface associated with a proprietary system. In one example, the machine-readable code may be presented pursuant to an access request detected by a user to access a proprietary database associated with the proprietary system. Once the token request is received, a unique token may be generated. The unique token may be generated in response to a user initiating access to the proprietary database. In one example, the unique token is to enable access to the proprietary database, when entered on an interface associated with the proprietary system. Thereafter, an access attempt for the user, may be recorded.

### BACKGROUND

Modern civilian aircrafts may communicate with a navigation database (NAVDB) to exchange data regarding waypoints, routes, departures, arrivals, airway procedures, constraints such as latitudinal and longitudinal values, frequencies, and such similar parameters, for completing a flight. Such data is utilized for implementing flight operations and assisting in avoiding conflicts with other air traffic or ground obstacles. The NAVDB is updated at regular intervals. Such an update is performed for maintenance of standard aircraft procedures, and also to update data that may be available within the NAVDB, which in turn may aid in flight-operation planning. The update is also required to maintain data accuracy, for planning logistics of the flight, and is a regulatory compliance for ensuring safety and security of the flight.

### BRIEF DESCRIPTION OF FIGURES

Systems and/or methods, in accordance with examples of the present subject matter are now described and with reference to the accompanying figures, in which:

FIG. 1 illustrates an access management system for authentication of navigation databases, as per an example;

FIG. 2 illustrates an environment comprising an access management system, an intermediary access device, and a navigational system, for authentication of navigation databases, as per an example;

FIG. 3 illustrates another environment comprising the access management system, the intermediary access device, and the navigational system for authentication of navigation databases, as per an example;

FIG. 4 illustrates components of the access management system, for authentication of navigation databases as per an example;

FIG. 5 illustrates components of the navigational system, for authentication of navigation databases, as per an example;

FIG. 6 illustrates an example call flow diagram representing communication between various computational entities for authentication of navigation databases, as per another example;

FIG. 7 illustrates an example navigational dashboard for authentication of navigation databases, as per an example;

FIG. 8 illustrates a method for authentication of navigation databases, as per an example;

FIG. 9 illustrates another method for authentication of navigation databases, as per an example;

FIG. 10 illustrates a detailed method for authentication of navigation databases, as per an example

FIG. 11 illustrates a computing environment implementing a non-transitory computer readable medium for authentication of navigation databases, as per an example.

### DETAILED DESCRIPTION

As may be understood, a flight management system is an on-board multi-purpose system for implementing flight operation(s) of a civilian aircraft, such as enabling flight preparation, calculating and delivering flyable trajectories to the crew associated with the flight, setting flight parameter(s) and providing guidance to the aircraft, as the flight progresses. The flight management system uses data obtained from various sensors to determine positional information of the aircraft during flight. The flight management system is configured to plan a route for the flight, calculate fuel levels, flight-time, altitude levels of the flight. As the aircraft in flight needs to cooperate closely with air traffic surveillance and control system(s), the flight management system integrates data from an avionics system of the aircraft, as well as data input directly by a pilot of the aircraft (during flight) or data communicated to the aircraft by an airline associated with the aircraft. The flight management system then causes the integrated data to be displayed for the crew, for optimal flight operation(s).

Generally, the flight management system may utilize a database, such as a navigation database (NAVDB), which contains information based on which a flight plan (for the civilian aircraft) is to be prepared. For example, the NAVDB may contain data required for building the flight plan, comprising, information about waypoints and/or intersections, airways, radio navigation aids, airports, runways, and more. The NAVDB may also comprise one of terrain data, navigation aids data, flight procedures data, arrival and departure data, latitudinal and longitudinal constraints data, and routes data, and combinations thereof. The NAVDB is generally updated after regular intervals (for example, every 28 days), in order to ensure that the NAVDB comprises the latest data. This update is necessary for ensuring safety, efficiency, and compliance with the flight operation(s). It further ensures that change(s) in airspace, routes, waypoints, airports, and terrain are accurately reflected.

Further, when a civilian aircraft is grounded at an airport, an off-board ground system operated by an airline (associated with the civilian aircraft) may connect through a dedicated connection with the aircraft to download prior flight information for analysis, or upload new data to the aircraft for future flight operations. A large volume of data may be exchanged in a relatively short period of time that the aircraft is grounded. Such an approach for authorizing the data exchange with the aircraft may be difficult to monitor or control, especially when additional cross-checks and/or varying levels of security clearance is desired thus allowing possibilities of unauthorized data access and/or acquisition.

Although cloud-based loading of the NAVDB may also be possible to prevent an unauthorized access, such an approach may involve use of higher bandwidth requirements and internet connectivity, which may not be possible in areas all situations. It may also be noted that given the sensitive nature of the information contained in the NAVDB, access to the NAVDB is controlled so that only authorized personnel may view or maintain data within the NAVDB. When accessing the NAVDB, a number of authentication mechanisms may be implemented to allow authorized personnel to access the database. Such considerations may be implemented to ensure that flight data, maintenance records, and other important information related to the aircraft or aircraft operations is sparingly accessed or at least accessed only when required. Permissions may be tailored to individual roles and secure access channels are used to establish remote connections, while accessing the NAVDB.

Presently, access to data within the NAVDB may not be monitored or tracked to determine the number of instances where such data may have been accessed or having different personnel access such information without reason or without proper authorization. There is often no mechanism to determine the number of times the NAVDB has been accessed, by whom, or whether such an access was properly authorized. It may not be ascertained that the personnel accessing the NAVDB has been duly authorized access the NAVDB for the number of times an access has been initiated. For example, the role of the personnel in question may entail such a personnel accessing the NAVDB ‘n’ number of times. Currently, there are no mechanisms which track whether the number (of times the access is initiated) has exceeded a specified (authorized) limit.

Additionally, subscription-based access model(s), wherein user(s) may be limited to a certain number of accesses, lack tracking and enforcement capabilities. Although certain conventional processes include authentication mechanisms such as password-based authentication, multi-factor authentication, role-based access control, biometric authentication, a public key infrastructure authentication, or the like, such approaches may not be entirely sufficient for monitoring or controlling access to the NAVDB. Also, traditional approaches may not track an access attempt of the user, trying to access the NAVDB. This recording of the access attempt may add further security to the traditional approaches and help maintain integrity of the NAVDB.

Approaches for authentication of navigation databases are provided. In one example, a user (for example, a maintenance personnel) may initiate access to a proprietary database, such as a NAVDB. The user may initiate access to the proprietary database, using an intermediary access device (via wired or wireless means of communication). To access the proprietary database, the user may initiate an access request using the intermediary access device. Based on the access request, a machine-readable code may be displayed on an interface associated with the proprietary database.

Thereafter, the machine-readable code may be scanned (using, for example, an image capturing device) by the user. The image capturing device may be implemented in a terminal device, which may scan and capture the machine-readable code presented on the intermediary access device. Based on scanning and subsequent processing of the machine-readable code, a token request may be generated by the terminal device. The token may be communicated to an access management system over a communication network.

Once the token request is received, a unique token may be generated by the access management system. In one example, the unique token may be a series of numbers, letters, special character, or an alphanumeric code, and combinations thereof, and is unique in respect to each token request. The generated token may thereafter be communicated to the terminal device. The received unique token may be entered (by the user) onto an interface of the intermediary access device. The unique token, once validated, may enable access to the proprietary database.

In an example, an access attempt for the user, may be recorded. In one example, a count associated with the recorded access attempt for the user may be determined. The count may be indicative of a number of attempts attempted by the user to access the proprietary database. The count may be compared with a pre-defined threshold limit. Based on the count being less than the pre-defined threshold limit, the unique token may be generated. In case the count is greater than the pre-defined threshold limit, an error notification may be triggered, wherein the error notification may indicate that the user has exceeded an allowed number of access attempts.

The present approaches offer several advantages over traditional methods. For example, a number of attempts (to access the proprietary database) may be recorded, which pertain to a number of times an access is initiated to the proprietary database. This may be beneficial to ensure that only authorized personnel have access to the proprietary database, and in case the number of attempts exceed a pre-defined threshold limit, the same may be notified to the concerned authorities for necessary action. Such approaches may help enhance security of the proprietary database, while maintaining ease of use, particularly in environments that may not have constant network access. Further, the present approaches may allow secure authentication and reduce the risk of unauthorized access to data within the proprietary database. It may also ensure that only licensed user(s) have access and update the proprietary database, thereby protecting valuable intellectual property and maintaining data integrity.

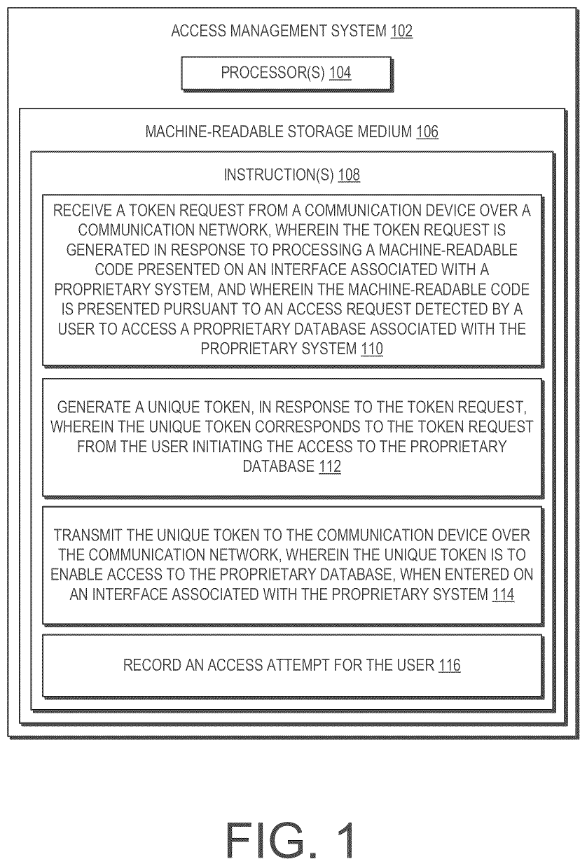

FIG. 1 illustrates an example access management system 102 (hereinafter referred to as the system 102) for authentication of navigation databases. The authentication of database services is based on an access attempt recorded for a user, requesting access to a proprietary database (for example, a navigation database, NAVDB), in accordance with an example of the present subject matter. The system 102 includes a processor 104, and a machine-readable storage medium 106 which is coupled to, and accessible by, the processor 104. The system 102 may be implemented in any computing system, such as a storage array, server, desktop or a laptop computing device, a distributed computing system, or the like. Although not depicted, the system 102 may include other components, such as interfaces to communicate over the network or with external storage or computing devices, display, input/output interfaces, operating systems, applications, data, and the like, which have not been described for brevity.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to classify the hardware components of the computing device.

In an example, the processor 104 may fetch and execute instructions 108. In one example, as a result of the execution of the instructions 110, the system 102 is to receive a token request. The token request may be received from a communication device over a first communication network. In one example, the token request may be generated in response to processing a machine-readable code. The machine-readable code may be presented on an interface associated with a proprietary system (for example, a navigational system). The machine-readable code may be generated by the proprietary system, and may be presented pursuant to an access request. In one example, the access request is detected when a user initiates access a proprietary database (NAVDB), associated with the proprietary system.

Once the token request is received, the instructions 112 may be executed to generate a unique token, in response to the token request. In one example, the unique token may correspond to the token request received from the user initiating the access to the proprietary database. The unique token may be a series of numbers, letters, or an alphanumeric code, and is unique in respect to each token request.

Once the unique token is generated, the instructions 114 may be executed to transmit the unique token to the communication device over the first communication network. Once the unique token is transmitted, it enables access to the proprietary database, when entered on an interface associated with the proprietary system. Further, once the unique token is entered on the interface, instructions 116 may be executed to record an access attempt for the user.

The above functionalities performed as a result of the execution of the instructions 108, may be performed by different programmable entities. Such programmable entities may be implemented through computing systems, which may be implemented either on a single computing device, or multiple computing devices. These and other examples are further described with respect to other figures.

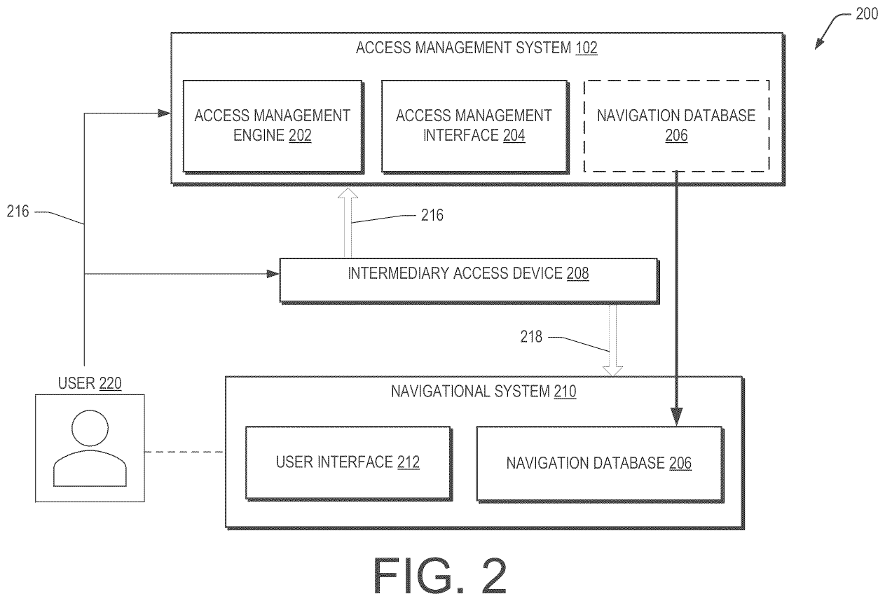

FIG. 2 illustrates an environment 200 comprising an access management system 102 (referred to as the system 102), an intermediary access device 208, and a navigational system 210. In an example, a user 220 may access (or attempt an access) the navigational system 210 through the intermediary access device 208 (interchangeably referred to as the access device 208).

The intermediary access device 208 is in communication with the access management system 102 via a first communication network 216. In one example, the first communication network 216 may be a private network or a public network and may be implemented as a wired network, a wireless network, or a combination of a wired and wireless network. The first communication network 216 may also include a collection of individual networks, interconnected with each other and functioning as a single large network, such as the Internet. Examples of such individual networks include, but are not limited to, Global System for Mobile Communications (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

Further, the intermediary access device 208 is coupled to the navigational system 210 via a link 218. In one example, the link 218 may be a wired or wireless link which allows the communication device 208 to communication and access the navigational system 210. Examples include, but are not limited to, a USB connection, and an ethernet connection (for example, a ARINC 664 (AFDX) communication protocol), for establishing communication between the intermediary access device 208 and the navigational system 210.

The access management system 102 further includes an access management engine 202, an access management interface 204, and a navigation database 206 (which may be synced with the navigational system 210 on a regular basis to provide an updated navigation database). The navigation database 206 may be a proprietary database associated with an aircraft, for which access is initiated by the user 220. The navigation database 206 may comprise, but not limited to, data regarding waypoints, routes, departures, arrivals, airway procedures, constraints such as latitudinal, and longitudinal values, frequencies, and airspace boundaries, of the aircraft. The navigation database 206 may also comprise one of terrain data, navigation aids data, flight procedures data, arrival and departure data, latitudinal and longitudinal constraints data, and routes data, and combinations thereof The access to the navigation database 206 may be related to one of an updating, reviewing, downloading, of data within the navigation database 206.

In one example, the access management interface 204 may present visual and/or functional elements through which the user 220 may interact with the access management system 102 (via the first communication network 216), to access the navigation database 206 (interchangeably referred as NAVDB). The access management interface 204 may facilitate the user 220 to access the navigation database 206.

Further, the navigational system 210 comprises a user interface 212 and the navigation database 206 (which may be loaded from the system 102 on a regular basis). The user interface 212, like the access management interface 204 may present visual and/or functional elements and is to facilitate access to the navigation database 206. The user 220, may be security and/or maintenance personnel, and initiate access to the navigation database 206 (via the link 218), for routine maintenance procedures.

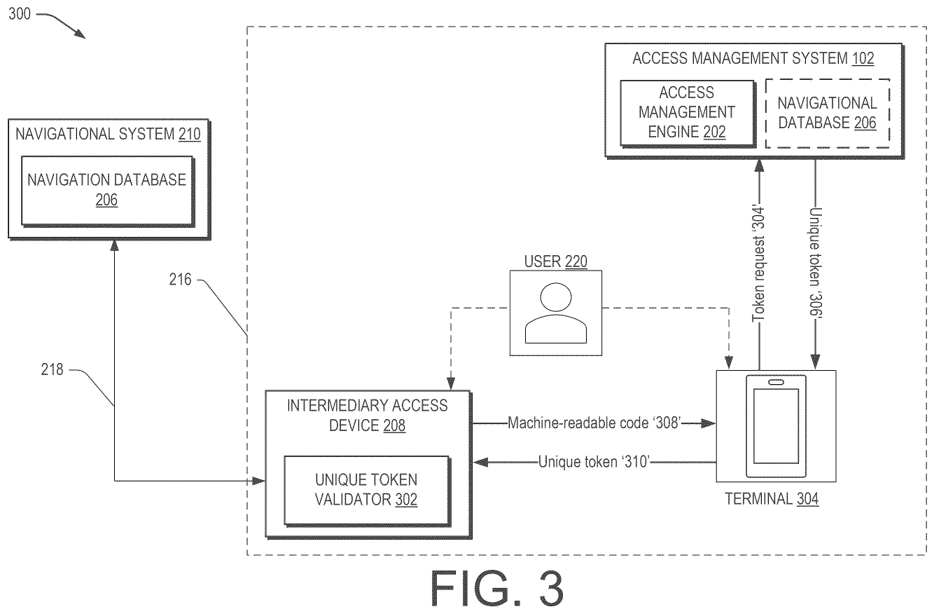

In operation, the navigation database 206 may be updated and/or loaded onto the navigational system 210. The same is facilitated via the intermediary access device 208, after due authentication by the system 102. The manner in which the system 102, the intermediary access device 208, and the navigational system 210 communicate is explained with respect to FIGS. 3-5.

FIG. 3 illustrates another example environment 300 comprising the access management system 102 (also referred to as the system 102), the intermediary access device 208, and the navigational system 210.

The environment 300 further includes a user, such as the user 220 initiating access to the navigational system 210, via the intermediary access device 208. Also, the environment 300 comprises of a terminal device 304, which the user 220 may use for gaining access. The terminal device 304 may be any handheld computing device comprising a display screen and input mechanisms, allowing the user 220 to view information, provide an input, and perform various operations related to the access to the navigation database 206. The terminal device 304 may serve as a point of interaction between the user 220 and the navigational system 210, facilitating the secure and efficient management of access to the navigation database 206 and other proprietary systems, associated with the navigational system 210. For example, the terminal device 304 may display a unique token to the user 220, so that the user 220 may enter the unique token on the user interface 212 associated with the navigational system 210.

In one example, the navigational system 210 includes the navigation database 206. In an example, the navigation database 206 may be associated with an aircraft associated with the navigational system 210, and comprises, but not limited to, data related to waypoints, routes, departures, arrivals, airway procedures, constraints such as latitudinal, and longitudinal values, frequencies, and airspace boundaries, of the aircraft. Although represented as a part of the navigational system 210, the navigation database 206 may be a separate functional element which may be in communication with the navigational system 210. Such implementations would continue to be within the scope of the present subject matter.

In one example, the navigational system 210 comprises the navigation database 206. In an example, the navigation database 206 may be associated with an aircraft associated with the navigational system 210, and comprises, but not limited to, data related to waypoints, routes, departures, arrivals, airway procedures, constraints such as latitudinal, and longitudinal values, frequencies, and airspace boundaries, of the aircraft.

The access management system 102 may comprise the access management engine 202 and the navigation database 206. The access management engine 202 may be implemented as a combination of hardware and programming, for example, programmable instructions to implement a variety of functionalities of the access management engine 202. In examples described herein, such combinations of hardware and programming may be implemented in several different ways. For example, the programming for the access management engine 202 may be executable instructions. Such instructions may be stored on a non-transitory machine-readable storage medium which may be coupled either directly with the system 102 or indirectly (for example, through networked means).

The access management engine 202 may include a processing resource, for example, either a single processor or a combination of multiple processors, to execute such instructions. In the present examples, the non-transitory machine-readable storage medium may store instructions that, when executed by the processing resource, implement access management engine 202. In other examples, the access management engine 202 may be implemented as electronic circuitry. In one example, the access management engine 202 may be implemented through a machine-learning model that implements machine-learning techniques, statistical techniques, or probabilistic techniques. Examples of such techniques may include expert systems, support vector machines (SVM), neural networks, or the like.

Further, the user 220 via the terminal device 304, and the system 102 may be communicatively coupled with each other over a communication network, such as the first communication network 216, as described in FIG. 2. The intermediary access device 208 may be communicatively coupled to the navigational system 210 via a network, such as the link 218, as described in FIG. 2. In one example, the intermediary access device 208 may comprise a unique token validator 302. The unique token validator 302 may be a processing circuitry, for validating the unique token received from the system 102, before the same is entered onto the interface 212.

In one example, the intermediary access device 208 may be a portable electronic device associated with the user 220, and may act as a bridge between the access management system 102 and the navigational system 210. The intermediary access device 208 may initiate access to the navigation database 206. The intermediary access device 208, may include, but is not limited to, a laptop, a computer, a handheld device used by the user 220. By serving as an intermediary, the intermediary access device 208 may, as will be explained further, enable a secure authentication and access to the navigation database 206, even in environments where direct network (for example, internet) connectivity to the navigational system 210 may be limited or unavailable.

In operation, the user 220 may initiate access to the navigation database 206. The user 220 may initiate access to the navigation database 206, using the intermediary access device 208 (via wired or wireless means of communication). To access the navigation database 206, the user 220 may initiate an access request on the navigational system 210, using the intermediary access device 208. Based on the access request, a machine-readable code may be displayed on an interface on the navigational system 210.

Thereafter, the machine-readable code may be scanned (using, for example, the terminal device 304) by the user 220. The terminal device 304 may scan and capture the machine-readable code presented on the an interface associated with the navigational system 210.

Based on the scanning of the machine-readable code (by the user 220) and subsequent processing of machine-readable code (by the system 102) the system 102 may receive a token request (represented by step ‘304’) from the intermediary access device 208. A unique token (represented by step ‘306’) (associated with the token request) may be generated in response to processing the machine-readable code (represented by step ‘308’), via the terminal device 304. For example, the machine-readable code may be presented on an interface, such as the user interface 212 associated with navigational system 210. The machine-readable code may be scanned by the terminal device 304 (which may be image capturing device). In one example, the machine-readable code may be a two-dimensional pattern of black and white squares or other geometric shapes, designed to be scanned and interpreted by the terminal device 304. Once the machine-readable code is scanned by the terminal device 304, a signal may be transmitted to the system 102 to generate a unique token (represented by step ‘310’). The access management engine 202 of the system 102 may then generate the unique token, in response to the token request.

Continuing further, the unique token may be received on the terminal device 304. The terminal device 304 may present the received unique token to the user 220 and the user 220 may input the unique token into the navigational system 210 (via the user interface 212). Once the unique token is entered onto the user interface 212, a record attempt may be recorded by the system 102. The record attempt may pertain to a number of attempts attempted by the user 220, to access the navigational system 210. In case the number of attempts is less than a pre-defined threshold limit, access may be granted to the navigational system 210. Else, an error notification may be triggered notifying that the user 220 may not be authorized to access the navigational system 210.

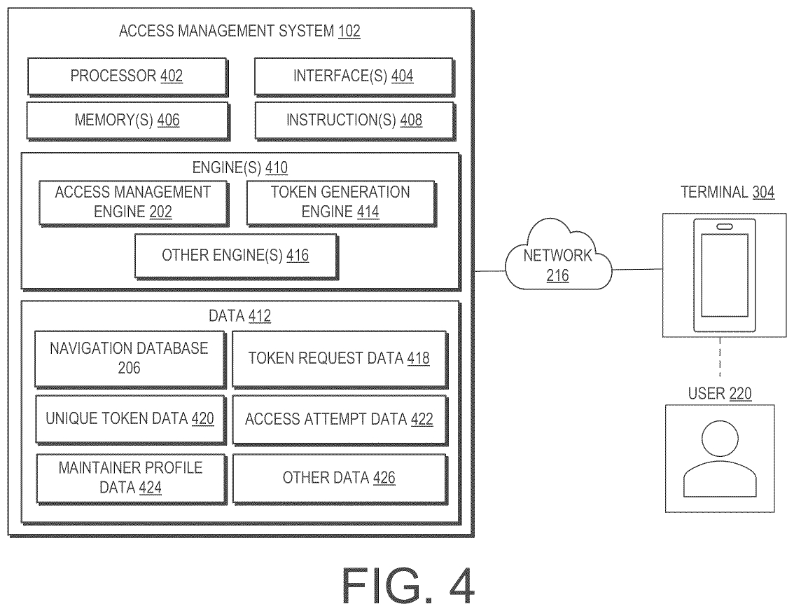

FIG. 4 illustrates components of the access management system 102 (also referred to as the system 102), for authentication of navigation databases, as per an example. The system 102 may be coupled to a terminal, such as the terminal device 304, via a network, such as the first communication network 216. The terminal device 304 may be associated with a user, such as the user 220, as the user initiates access to navigation database 206. As described previously, the first communication network 216 may be a private network or a public network and may be implemented as a wired network, a wireless network, or a combination of a wired and wireless network. The first communication network 216 may also include a collection of individual networks, interconnected with each other and functioning as a single large network, such as the Internet. Examples of such individual networks include, but are not limited to, Global System for Mobile Communications (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The system 102 may include a processor 402, interface(s) 404, and memory 406. The processor 402 may be implemented as microprocessors, microcomputers, microcontrollers, digital signal processors, central processing units, state machines, logic circuitries, and/or other devices that manipulate signals based on operational instructions. Among other capabilities, the processor 402 may be configured to generate and transmit a unique token, in response to a token request received from a user accessing a navigation database. The processor 402 may then use an access management engine 202 and a token generation engine 414 to generate and transmit a unique token, in response to a token request received from a user accessing a navigation database. In an example, the processor 402 may also be capable of performing authentication of navigation databases within an environment, such as the environment 200 and the environment 300, as explained in FIGS. 2-3.

The interface(s) 404 may allow the connection or coupling of the system 102 with one or more computing devices such as a terminal device 304, through a wired network, a wireless network, or a combination of a wired and wireless network. The interface(s) 404 may also enable intercommunication between different logical as well as hardware components of the system 102.

The memory 406 may be a computer-readable medium, examples of which include volatile memory (e.g., RAM), and/or non-volatile memory (e.g., Erasable Programmable read-only memory, i.e., EPROM, flash memory, etc.). The memory 406 may be an external memory, or internal memory, such as a flash drive, a compact disk drive, an external hard disk drive, or the like. The memory 406 may further include data which either may be utilized or generated during the operation of the system 102.

The system 102 may further include instructions 408 and engine(s) 410. In an example, the instructions 408 are fetched from the memory 406 and executed by the processor 402 included within the system 102. The engine(s) 410 may include the access management engine 202, the token generation engine 414, and other engine(s) 416. The other engine(s) 416 may further implement functionalities that supplement functions performed by the system 102 or any of the engine(s) 410. The access management engine 202 and the token generation engine 414 may be implemented as a combination of hardware and programming, for example, programmable instructions to implement a variety of functionalities. In examples described herein, such combinations of hardware and programming may be implemented in several different ways.

For example, the programming for the access management engine 202 may be executable instructions, such as instructions 408. Such instructions 408 may be stored on a non-transitory machine-readable storage medium which may be coupled either directly with the system 102 or indirectly (for example, through networked means). In an example, the access management engine 202 may include a processing resource, for example, either a single processor or a combination of multiple processors, to execute such instructions. In the present examples, the non-transitory machine-readable storage medium may store instructions, such as instructions 408, that when executed by the processing resource, implement the access management engine 202 and the token generation engine 414. In other examples, the access management engine 202 and the token generation engine 414 may be implemented as electronic circuitry.

The system 102 may further include data 412. The data 412 may include corresponding data that is utilized or generated by the system 102, while performing a variety of functions. In an example, the data 412 further includes navigation database 206, token request data 418, unique token data 420, access attempt data 422, maintainer profile data 424, and other data 426. Further, the other data 426, amongst other things, may serve as a repository for storing data that is processed, or received, or generated as a result of the execution of the instructions by the processor 402.

In operation, initially, the user 220 may initiate access to the navigation database 206. The user 220 may initiate access to the navigation database 206, using the intermediary access device 208 (via wired or wireless means of communication). To access the navigation database 206, the user 220 may initiate an access request on the navigational system 210, using the intermediary access device 208. Based on the access request, a machine-readable code may be displayed on an interface on the navigational system 210. Thereafter, the machine-readable code may be scanned (using, for example, the terminal device 304) by the user 220. The terminal device 304 may scan and capture the machine-readable code presented on the an interface associated with the navigational system 210.

Based on the scanning of the machine-readable code (by the user 220) and subsequent processing of machine-readable code (by the system 102), the system 102, and in turn, the access management engine 202 may receive a token request from an intermediary access device, such as the intermediary access device 208, described in FIG. 3. The token request may be received when the user 220 initiates access to the navigational system 210. For example, the token request may be received from the intermediary access device 208. The token request received may be stored as the token request data 418.

In one example, the machine-readable code may be presented on an interface, such as the user interface 212, associated with the navigational system 210. As discussed previously, the machine-readable code may be a two-dimensional pattern of black and white squares or other geometric shapes, designed to be scanned by the terminal device 304. The user 220, may, using the terminal device 304 scan the machine-readable code displayed on the user interface 212. Once the machine-readable code is scanned by the terminal device 304, a signal may be transmitted to the system 102 to generate a unique token.

Continuing further, the token request may be received by the system 102 when the intermediary access device 208, is in communication (via a wired or a wireless network) with the navigational system 210. Since the intermediary access device 208 is communicatively coupled to the navigational system 210 via the link 218 (as described in FIGS. 2-3), the intermediary access device 208 may be coupled to the navigational system 210 via, for example, an ethernet cable. As the cable is connected to the navigational system 210, the access request to access the navigational system 210 may be detected, by the navigational system 210. The generation of the token and subsequent steps may continue only once the access request is detected. In one example, the access request may correspond to the token request. When the token request is received, the token generation engine 414 may generate a unique token. In one example, the unique token may be a series of numbers, letters, special character, or an alphanumeric code, and combinations thereof, and is unique in respect to each token request.

Once the unique token is generated, the access management engine 202 may transmit the unique token to the terminal device 304, associated with the user 220. The user 220 may enter the unique token displayed on the terminal device 304, onto the user interface 212 associated with the navigational system 210. The unique token entered on the interface 212 may be validated by the navigational system 210. Once the unique token is validated, it may enable access to the navigation database 206, associated with the navigational system 210.

Further, once the unique token is entered on the user interface 212, the access management engine 202 may record an access attempt for the user 220. In one example, the unique token generated may be stored as the unique token data 420. The token request and the subsequent generation of the unique token is shown below in Table 1:

TABLE 1

| Token request (initiated by user via | Unique token (received |
|---|---|
| intermediary access device) | by terminal device 304) |
| User initiated token request - 1 | ‘4&23*HT!A’ |
| User initiated token request - 2 | ‘8#10*GAA%’ |
| User initiated token request - 3 | ‘XXXX*HT!A’ |
| User initiated token request - 4 | ‘8#10*TFS$’ |

For example, from the above Table 1, it may be gathered that the user-initiated access attempt corresponds to ‘4’. For each access attempt, the unique token is generated, which may be valid for a pre-defined period of time. For example, the unique token may be valid for 10 minutes. The user 220, may enter the unique token received on the terminal device 304, onto the interface 212, within 10 minutes. If the unique token is not entered within stipulated time, access to the navigational system 210 may not be granted, and the user 220 may need to initiate another access request.

It may be noted that in case of a failed attempt to access the navigation database 206, a number of attempts may still be recorded (and stored as the access attempt data 422). It may be noted that the recording of the access attempt is associated with determining a count of attempts, attempted by the user 220. The count may be indicative of a number of attempts, attempted by the user to access the navigation database. The count may be compared with a pre-defined threshold limit, and when the count is less than the pre-defined threshold limit, the unique token may be generated. Else, when the count may be greater than the pre-defined threshold limit, an error notification may be generated warning the system 102, that the attempt to access the proprietary database, may be unauthorized.

For example, the access management engine 202 may be implemented to maintain a record of the user 220 and store the same as maintainer profile data 424. The maintainer profile data 424 may comprise of a set of information stored within the access management system 102, pertaining to individual user(s) authorized to access and maintain the navigation database 206. In an example, the maintainer profile data 424 may encompass various elements including, but not limited to, user identification information, authentication credentials, access privileges, history of access attempts and successful logins, records of database updates or modifications, relevant training and certification information, and any specific restrictions or permissions granted to the user 220. It may also comprise a time-based access control and information about intermediary access device(s) 208 associated with each user, such as the user 220. The maintainer profile data 424 may help in the authentication and authorization process, enabling the system 102 to verify user identities, track activities for auditing purposes, and enforce security policies tailored to individual user profiles. By maintaining detailed maintainer profiles, the system 102 may help ensure that only trained and authorized personnel may access sensitive aircraft systems, thereby preserving the integrity and security of the navigation database 206.

Further, for each user 220 (and ultimately to an organization to which the user 220 is associated), a number of attempts to access the navigation database 206 may be defined. For example, the navigation database 206, updated on a regular basis, may be obtained and consolidated by a handful of organizations. The consolidated data may then be sold in industry-standard formats to large third-party supplier(s) of aircraft system(s) and vendor(s) (which may be a license server) of a navigation database, such as the navigation database 206. For example, such vendor(s) may process the navigation database 206 to compile the data within the database and distribute it to an airplane. The vendor may maintain the navigation database 206 or listing of specific aircraft which may be authorized to receive updated corresponding to the navigation database 206. It may be understood that an aircraft is typically not connected to a network (such as the internet) during time on the ground or in maintenance. Therefore, the user 220 may use local data means (for example, the intermediary access device 208 which may be an Ethernet loader), to load the updated navigation database 206 onto the airplane(s).

Returning to the present example, if the number of permitted attempts to access the navigation database 206 is ‘50’, and the count of attempts exceeds this threshold limit, the access management engine 202, may flag that the user 220 has exceeded a pre-defined number of attempts. This may prevent unauthorized access attempts and enhance security of the navigation database 206. The system 102, may thus implement various actions when the threshold is exceeded, such as temporarily locking the user's account, requiring additional authentication step(s), or alerting system administrator(s). By limiting the number of access attempts, the system 102 may also help mitigate a risk of unauthorized user(s) trying to gain access to the navigation database 206 through repeated attempts. This feature may add an extra layer of security to protect the navigation database 206 from potential misuse.

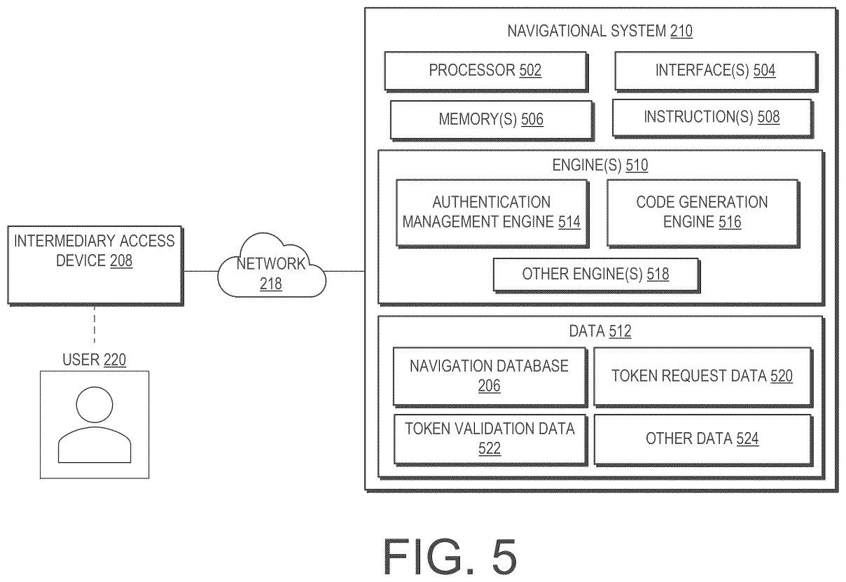

FIG. 5 illustrates components of the navigational system 210, for authentication of navigation databases, as per an example.

In an example, the navigational system 210 may generate and transmit a machine-readable code, in response to an access request received from a user, such as the user 220 accessing navigation database 206. The navigational system 210 may be coupled to an intermediary access device, such as the intermediary access device 208, via a link, such as the link 218, as described in FIG. 2. As described previously, the link 218 may be a private network and may be implemented as a wired network, a wireless network, or a combination of a wired and wireless network, for example, a USB connection, and an ethernet connection, for establishing communication between the intermediary access device 208 and the navigational system 210.

The navigational system 210 may include a processor 502, interface(s) 504, and memory 506. The processor 502 may be implemented as microprocessors, microcomputers, microcontrollers, digital signal processors, central processing units, state machines, logic circuitries, and/or other devices that manipulate signals based on operational instructions. Among other capabilities, the processor 502 may be configured to generate and transmit a machine-readable code in response to an access request received from a user accessing a navigation database. The processor 502 may then use an authentication management engine 514 and a code generation engine 516, to generate and transmit the machine-readable code. In an example, the processor 502 may also be capable of performing authentication of database services within the networked environment, such as environment 200 and environment 300, as explained in FIGS. 2-3.

The interface(s) 504 may allow the connection or coupling of the system 102 with one or more computing devices such as the intermediary access device 208, through a wired network, a wireless network, or a combination of a wired and wireless network. The interface(s) 504 may also enable intercommunication between different logical as well as hardware components of the navigational system 210.

The memory 506 may be a computer-readable medium, examples of which include volatile memory (e.g., RAM), and/or non-volatile memory (e.g., Erasable Programmable read-only memory, i.e., EPROM, flash memory, etc.). The memory 506 may be an external memory, or internal memory, such as a flash drive, a compact disk drive, an external hard disk drive, or the like. The memory 506 may further include data which either may be utilized or generated during the operation of the navigational system 210.

The navigational system 210 may further include instructions 508 and engine(s) 510. In an example, the instructions 508 are fetched from the memory 506 and executed by the processor 502 included within the navigational system 210. The engine(s) 510 may include the authentication management engine 514, the code generation engine 516, and other engine(s) 518. The other engine(s) 518 may further implement functionalities that supplement functions performed by the navigational system 210 or any of the engine(s) 518. The authentication management engine 514 and the code generation engine 516 may be implemented as a combination of hardware and programming, for example, programmable instructions to implement a variety of functionalities. In examples described herein, such combinations of hardware and programming may be implemented in several different ways.

For example, the programming for the authentication management engine 514 and the code generation engine 516 may be executable instructions, such as instructions 508. Such instructions 508 may be stored on a non-transitory machine-readable storage medium which may be coupled either directly with the navigational system 210 or indirectly (for example, through networked means).

In an example, the authentication management engine 514 and the code generation engine 516 may include a processing resource, for example, either a single processor or a combination of multiple processors, to execute such instructions. In the present examples, the non-transitory machine-readable storage medium may store instructions, such as instructions 508, that when executed by the processing resource, implement the authentication management engine 514 and the code generation engine 516. In other examples, the authentication management engine 514 and the code generation engine 516 may be implemented as electronic circuitry.

The navigational system 210 may further include data 512. The data 512 may include corresponding data that is utilized or generated by the navigational system 210, while performing a variety of functions. In an example, the data 512 further includes navigation database 206, token request data 520 (same as token request data 418 as explained in FIG. 4), token validated data 522, and other data 524. Further, the other data 524, amongst other things, may serve as a repository for storing data that is processed, or received, or generated as a result of the execution of the instructions by the processor 502.

In operation, initially, the navigational system 210, and in turn, the code generation engine 516 may receive an access request from an intermediary access device, such as the intermediary access device 208. As discussed in conjunction to FIG. 4, the intermediary access device 208 may be communicatively coupled to the navigational system 210 via the link 218, the intermediary access device 208 may be connected to the navigational system 210 via, for example, a cable. As the cable is connected to the navigational system 210, an access request to access the navigational system 210 may be detected, by the code generation engine 516 of the navigational system 210. The access request may correspond to the user 220 accessing the navigation database 206. The access request may correspond to the token request, when it is detected, that the user 220 initiates access to the navigation database 206.

Pursuant to the access request, a machine-readable code may be generated, by the code generation engine 516. As discussed previously, the machine-readable code may be a two-dimensional pattern of black and white squares or other geometric shapes, designed to be scanned and interpreted by an image capturing device such as a camera or scanner (such as the terminal device 304 explained in FIG. 4). Examples of the machine-readable code include, but are not limited to, a QR (Quick Response) code, a barcode, or other similar optical machine-readable representations of data.

The machine-readable code may encode information related to the access request, such as a unique identifier associated with the navigational system 210, a timestamp, or other relevant data corresponding to the access request, without deviating from the scope of the present subject matter. The machine-readable code may be displayed on an interface, such as the user interface 212 associated with the navigational system 210. The user 220, may, using the terminal device 304 scan the machine-readable code displayed on the user interface 212. Pursuant to the generation of the machine-readable code, the authentication management engine 514 may transmit a signal to the system 102. The signal may be transmitted pursuant to scanning of the machine-readable code by the terminal device 304. In one example, the signal may be associated with generation of a unique token by the system 102.

For example, the unique token may be a series of numbers, letters, special characters, or an alphanumeric code, and combinations thereof, and is unique in respect to a token request. Once the unique token is generated, the authentication management engine 514 may display an interface, such as the user interface 212. The unique token may be entered onto the user interface 212 by the user 220. Once the unique token is transmitted, it enables access to the navigation database 206, associated with the navigational system 210. Further, once the unique token is entered on the user interface 212, the same may be validated by the authentication management engine 514, and stored as the token validated data 522.

In one example, upon receiving the token via the user interface 212, the authentication management engine 514 may compare the same against an expected unique token associated with a specific access request and the machine-readable code associated thereof. The authentication management engine 514 may be implemented to perform a check on a validity period of the unique token. The authentication management engine 514 may be implemented to record a validated attempt pertinent to the access request thereof, update an access attempt of the user 220, and compare the same against a predefined threshold limit. Based on the same, the authentication management engine 514 may be implemented to generate a response, either granting access to the navigation database 206 for the validated unique token or denying access and triggering security measures for an invalid or a suspicious token request.

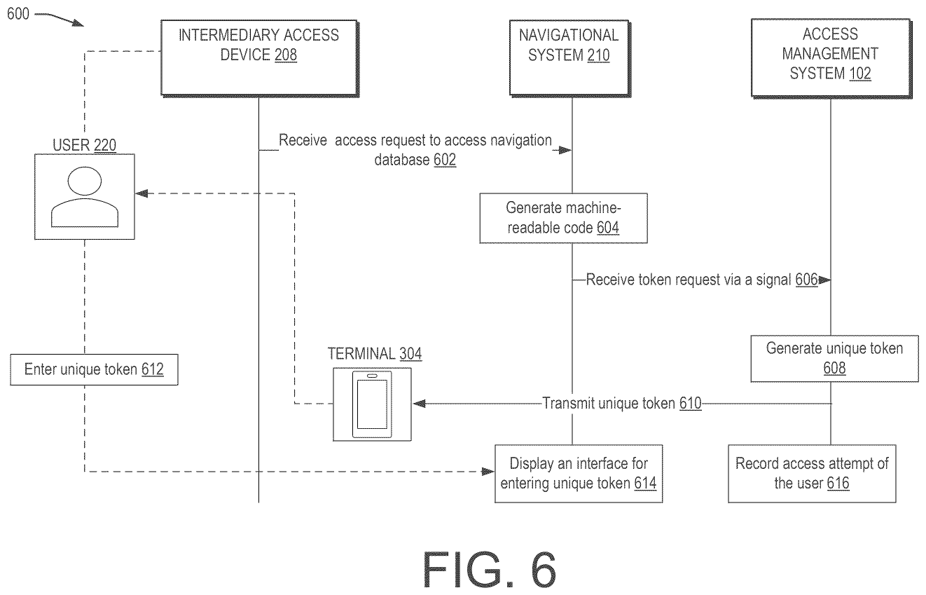

The above approaches are further explained in conjunction with an exemplary call flow diagram as illustrated in FIG. 6. FIG. 6 illustrates an example call flow diagram 600 representing communication between various computational entities of the environments 200 and 300, explained in FIGS. 2-3, as per one example.

As described previously, a user, such as the user 220, engages with the navigational system 210, the access management system 102, and the intermediary access device 208, which may range from a desktop computer to a mobile phone, to initiate access to the navigation database 206 of the navigational system 210. As discussed previously, the user 220, may be a security and/or maintenance personnel, and may initiate access to the navigation database 206 (of the navigational system 210), for routine maintenance procedure(s). The user 220 may refer to an individual authorized to access and interact with the navigational system 210.

As the user 220 interacts with the navigational system 210, a unique token may be generated. For generating the unique token, an access request (as indicated by step ‘602’) may be sent from the intermediary access device 208 to the navigational system 210. The access request may be indicative of the user 220, initiating access to the navigation database 206 of the navigational system 210. Pursuant to receiving the access request from the intermediary access device 208, a machine-readable code may be generated (as indicated by step ‘604’) on an interface associated with the navigational system 210. For example, an interface, such as the user interface 212 may display a visual representation of the machine-readable code. The machine-readable code may be scanned by a terminal, such as the terminal device 304. The scanning of the machine-readable code may generate a signal, which may cause the access management system 102 to receive (as indicated by step ‘606’) a token request.

The access management engine 202 of the system 102 may then generate (as indicated by step ‘608’) a unique token, in response to the token request. In one example, the unique token may be a series of numbers, letters, special character, or an alphanumeric code, and combinations thereof, and is unique in respect to each token request. Once the unique token is generated, the access management engine 202 may transmit (as indicated by step ‘610’) the unique token to the terminal device 304, associated with the user 220. The user 220 may read the unique token transmitted to the terminal device 304, and enter (as indicated by step ‘612’) the unique token on an interface. For example, an interface, such as the user interface 212 may be displayed (as indicated by step ‘614’) so that the user 220 may enter the unique token onto the interface 212. Further, once the unique token is entered on the user interface 212, the access management engine 202 may record (as indicated by step ‘616’) an access attempt for the user 220, and access may be granted to the navigation database 206.

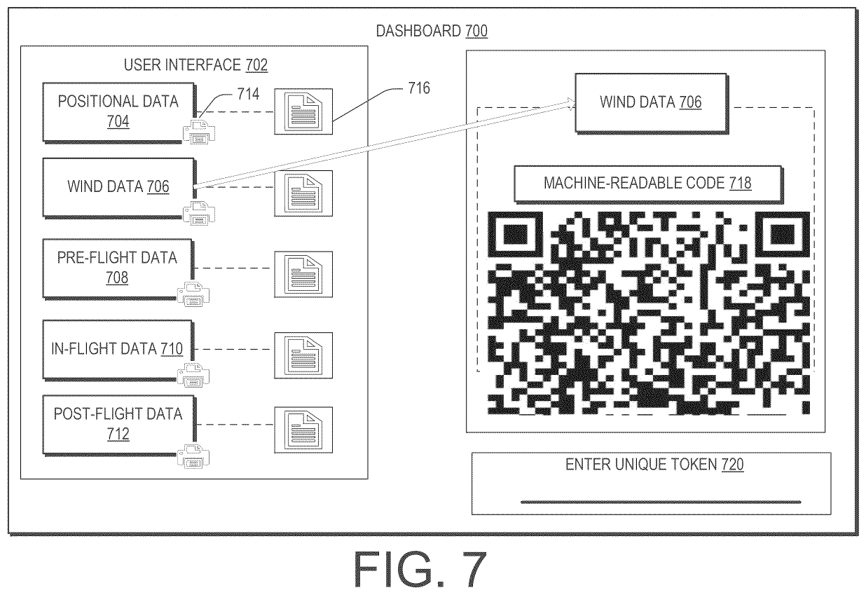

FIG. 7 illustrates an example navigational dashboard 700, which may be implemented as part of the navigational system 210 described in FIGS. 2-5. In one example, the navigational dashboard 700 includes a user interface 702 (same as the user interface 212). The user interface 702 comprises one or more informational sections and sub-sections. The informational sections may provide information pertaining to different data elements as discussed in conjunction with the preceding figures. The user interface 702 may present various data interfaces, sections, and sub-sections related with the navigation database 206. The navigation database 206 and may comprise, but not limited to, data regarding waypoints, routes, departures, arrivals, airway procedures, constraints such as latitudinal, and longitudinal values, frequencies, and airspace boundaries, of a civilian aircraft.

For example, the user interface 702 may include a visual representation or various blocks comprising one or more selectable options to select data, such as positional data 704, wind data 706, pre-flight data 708, in-flight data 710, and post-flight data 712. The data (704, . . . , 712) may be associated with the civilian aircraft, for which a navigation database (such as navigation database 206) is to be updated and/or downloaded. Further, widgets 714 and 716 may pertain to displaying/or printing data present within the one or more selectable options (704, . . . , 712). The user 220 may view data within each of the selectable options (704, . . . , 712), by selecting the widgets 714 and 716. However, the user 220 may only be able to view the data within the selectable options (704, . . . , 712), when access is enabled to the user 220.

In one example, the positional data 704 may display real-time information about the aircraft's current location, aligning with the essential data regarding waypoints and routes associated with the aircraft. The wind data 706 may present information about current and forecasted wind conditions, which is crucial for flight planning and operations. The preflight data 708, inflight data interface 710, and postflight data interface 712 may correspond to different phase(s) of flight operation(s), associated with the said civilian aircraft.

In an example, the interface 702 may also comprise a machine-readable code display 718 and a display 720 to enter a unique token. During operation, the display 718 may display a machine-readable code, which may be an optical code, when an access request is detected from a user (such as the user 220) initiating access to the navigation database 206. For example, the machine-readable code may be presented on the user interface 702 pursuant to the access request. Pursuant to the generation of the machine-readable code, a signal is transmitted to the system 102 to generate a unique token. The signal is transmitted pursuant to scanning of the machine-readable code by the terminal device 304, as explained in FIGS. 2-5. Once the signal is transmitted, the system 102 may generate the unique token and send the unique token to the terminal device 304 associated with the user 220. The user 220 may enter the unique token onto the display 720. Once the unique token is added onto the display 720, an access attempt may be recorded by the system 102.

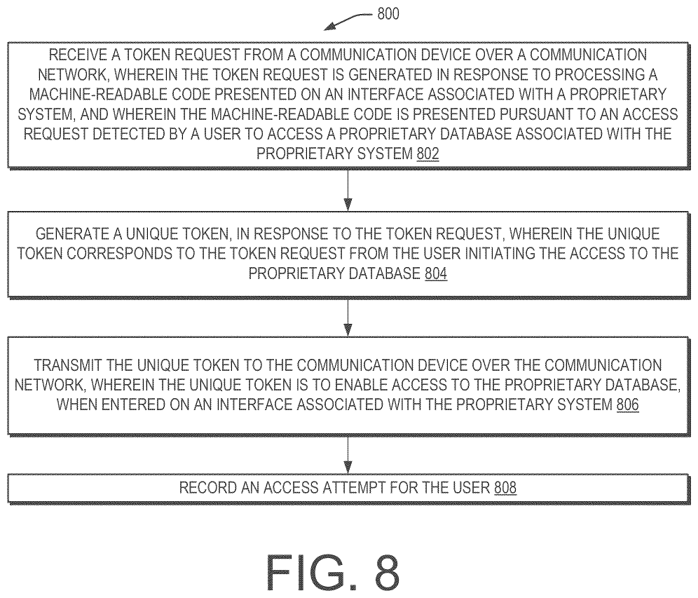

FIG. 8 illustrates a method 800 for authentication of navigation databases, as per an example. The order in which the above-mentioned method is described is not intended to be construed as a limitation, and some of the described method blocks may be combined in a different order to implement the method, or an alternative method.

Furthermore, the above-mentioned method may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by an access management system, also referred as system 102 (and in turn by the access management engine 202 and the token generation engine 414 of the system 102). In an implementation, the method may be performed under an “as a service” delivery model, where the system 102, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 800 may be implemented by the system 102 for recording an access attempt of a user, initiating access to a navigation database, such as the navigation database 206 associated with the navigational system 210, as described in FIG. 2. The present method 800 is explained from the perspective of the navigation database 206 being accessed. Although the present explanation is provided in relation to a proprietary database, such as the navigation database 206, these approaches may also be applicable for any other database (such as terrain databases, aero engine databases, and more, without deviating from the scope of the present subject matter) associated with the navigational system 210. Such implementations too would fall within the scope of the present subject matter.

At block 802, a token request is received. For example, the system 102, and in turn, an access management engine 202 of the system 102 may receive a token request from an intermediary access device, such as the intermediary access device 208, described in FIGS. 3-4. For example, the user 220 may initiate access to a proprietary system, such as the navigational system 210. The token request received may be generated in response to processing of a machine-readable code. For example, the machine-readable code may be presented on an interface, such as the user interface 212, pursuant to an access request. The token request may be received when the intermediary access device 208, is in communication (via a wired or a wireless network) with a navigational system, such as the navigational system 210. Since the intermediary access device 208 is communicatively coupled to the navigational system 210 via the link 218, an access request to access the navigational system 210 may be recorded. The generation of the unique token and subsequent steps may continue once the access request is detected.

At block 804, a unique token is generated. For example, the access request may correspond to the token request, and be associated with the user 220, when it is detected, that the user 220, via the intermediary access device 208, initiates access to a proprietary database, such as the navigation database 206. Pursuant to receiving the token request, the token generation engine 414 may generate a unique token. In one example, the unique token may be a series of numbers, letters, special character, or an alphanumeric code, and combinations thereof, and is unique in respect to each token request.

At block 806, the unique token is transmitted. For example, once the unique token is generated, the access management engine 202 transmits the unique token to the terminal device 304, associated with the user 220. Once the unique token is transmitted, it enables access to the navigation database 206, when entered on the user interface 212 associated with the navigational system 210. For example, the user 220 may enter the unique token displayed on the terminal device 304, onto the user interface 212 associated with the navigational system 210. The unique token entered on the interface 212 may be validated by the navigational system 210. Once the unique token is validated, it may enable access to the navigation database 206, associated with the navigational system 210.

At block 808, an access attempt is recorded. Once the unique token is entered onto the user interface 212, the access management engine 202 may record an access attempt for the user 220. As discussed previously, recording of the access attempt is associated with determining a count of attempts, attempted by the user 220. The count may be indicative of a number of attempts, attempted by the user to access the navigation database. The count may be compared with a pre-defined threshold limit, and when the count is less than the pre-defined threshold limit, the unique token may be generated. Else, when the count may be greater than the pre-defined threshold limit, an error notification may be generated warning the system 102, that the attempt to access the proprietary database, may be unauthorized.

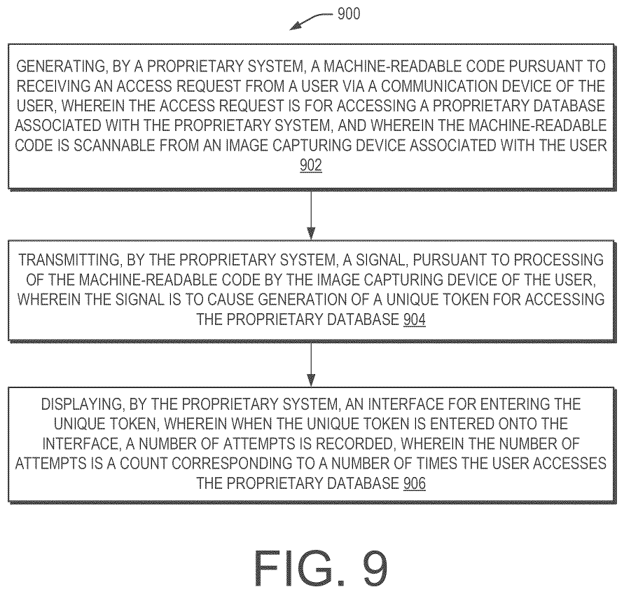

FIG. 9 illustrates a method 900 for authentication of navigation databases, as per an example. The order in which the above-mentioned method is described is not intended to be construed as a limitation, and some of the described method blocks may be combined in a different order to implement the method, or an alternative method.

Furthermore, the above-mentioned method 900 may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method 900 may be performed by a navigational system, also referred to as the navigational system 210 (and in turn the authentication management engine 514 and the code generation engine 516 of the navigational system 210). In an implementation, the method may be performed under an “as a service” delivery model, where the navigational system 210, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 900 may be implemented by the navigational system 210 generating a machine-readable code, when the user initiates access to a navigation database, such as the navigation database 206 associated with the navigational system 210, as described in FIG. 2. The present method 900 is explained from the perspective of a proprietary database, such as the navigation database 206 being accessed. Although the present explanation is provided in relation to the navigation database 206, these approaches may also be applicable for any other database associated with the navigational system 210. Such implementations too would fall within the scope of the present subject matter.

At block 902, a machine-readable code is generated. For example, the navigational system 210, and in turn, the code generation engine 516 of the navigational system 210 may receive an access request from an intermediary access device, such as the intermediary access device 208. Pursuant to the access request, a machine-readable code may be generated, by the code generation engine 516. In one example, the machine-readable code may be a two-dimensional pattern of black and white squares or other geometric shapes, designed to be scanned and interpreted by an image capturing device such as a camera or scanner (such as the terminal device 304 explained in FIGS. 3-4).

At block 904, a signal is transmitted. For example, pursuant to the generation of the machine-readable code, the authentication management engine 514 of the navigational system 210 may transmit a signal to the intermediary access device 208. The signal may be transmitted pursuant to scanning of the machine-readable code by the terminal device 304. In one example, the signal is to cause generation of a unique token.

At block 906, an interface is displayed. For example, once the unique token is generated, the authentication management engine 514 may display an interface, such as the user interface 212. The unique token may be entered onto the user interface 212 by the user 220. Once the unique token is transmitted, it may enable access to the navigation database 206. Further, once the unique token is entered on the user interface 212, the access management engine 202 of the system 102, may record an access attempt of the user 220. The recording of the access attempt may pertain to the user 220 accessing the navigation database 206.

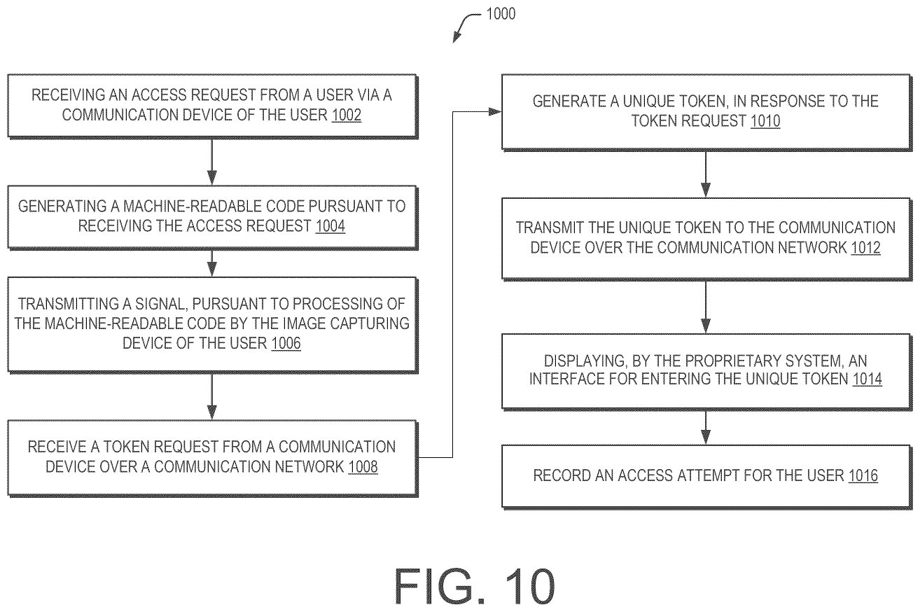

FIG. 10 illustrates a detailed method 1000 for authentication of navigation databases, as per an example. The order in which the above-mentioned method is described is not intended to be construed as a limitation, and some of the described method blocks may be combined in a different order to implement the method, or an alternative method.

Furthermore, the above-mentioned method may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by the access management system 102 and the navigational system 210 (by respective engine(s)), as explained in FIGS. 2-5. In an implementation, the method may be performed under an “as a service” delivery model, where the access management system 102, and the navigational system 210, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

At block 1002, an access request is received. For example, the navigational system 210, and in turn, the code generation engine 516 may receive an access request from an intermediary access device, such as the intermediary access device 208, associated with a user, such as the user 220. The access request may correspond to the user 220 initiating access to the navigational system 210.

At block 1004, a machine-readable code is generated. In one example, pursuant to the access request, a machine-readable code may be generated, by the code generation engine 516. As described previously, the machine-readable code may be a two-dimensional pattern of black and white squares or other geometric shapes, designed to be scanned and interpreted by an image capturing device such the terminal device 304. The machine-readable code is generated by the navigational system 210, and in turn the code generation engine 516, in response to the access request and is displayed on an interface for a user, such as the user 220, to scan using the terminal device 304.

At block 1006, a signal is transmitted. For example, pursuant to the generation of the machine-readable code, an authentication management engine 514 of the navigational system 210 may transmit a signal to the intermediary access device 208. The signal may be transmitted pursuant to scanning of the machine-readable code by the terminal device 304. In one example, the signal is to cause generation of a unique token.

At block 1008, a token request is received. In an example, the system 102, and in turn, an access management engine 202 of the system 102 may receive a token request from an intermediary access device, such as the intermediary access device 208, pursuant to scanning of the machine-readable code displayed on the interface 212 of the navigational system 210. For example, when the user 220 may initiate access to the navigational system 210, the token request is generated.

At block 1010, a unique token is generated. Pursuant to receiving the token request, the token generation engine 414 may generate a unique token. As explained previously, the unique token may be a series of numbers, letters, special character, or an alphanumeric code, and combinations thereof, and is unique in respect to each token request.

At block 1012, the unique token is transmitted. For example, once the unique token is generated, the access management engine 202 transmits the unique token to the terminal device 304, associated with the user 220.

At block 1014, an interface is displayed. For example, once the unique token is generated, the authentication management engine 514 may display an interface, such as the user interface 212. The unique token may be entered onto the user interface 212 by the user 220. Once the unique token is transmitted, the user 220 may enter the unique token onto the interface 212. Once the unique token is entered onto the interface 212, access to the navigation database 206 may be enabled.

At block 1016, an access attempt is recorded. For example, once the unique token is entered on the user interface 212, the access management engine 202 may record an access attempt for the user 220. As discussed previously, recording of the access attempt may be associated with determining a count of attempts, attempted by the user 220. The count may be indicative of a number of attempts, attempted by the user to access the navigation database. The count may be compared with a pre-defined threshold limit, and when the count is less than the pre-defined threshold limit, the unique token may be generated. Else, when the count may be greater than the pre-defined threshold limit, an error notification may be generated warning the system 102, that the attempt to access the proprietary database, may be unauthorized. When it is determined that the count is greater than the pre-defined threshold limit, an error notification may be triggered. For example, an error notification may be triggered on an interface associated with the system 102, indicating that user 220 has exceeded an allowed number of access attempts.

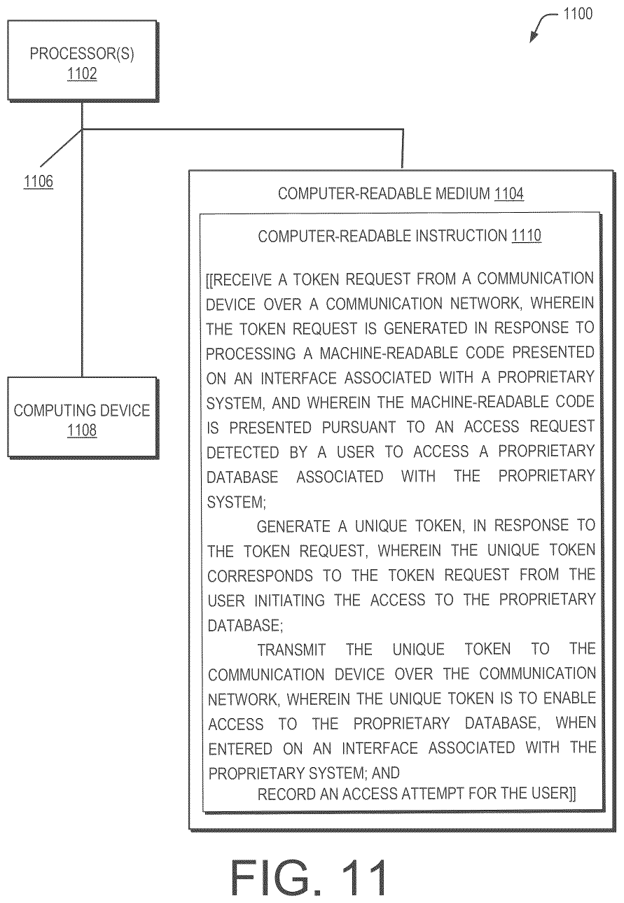

FIG. 11 illustrates a computing environment 1100 implementing a non-transitory computer readable medium for authentication of navigation databases, as per an example. In an example, the computing environment 1100 includes processor(s) 1102 communicatively coupled to a non-transitory computer readable medium 1104 through a communication link 1106. In an example, the processor(s) 1102 may have one or more processing resources for fetching and executing computer-readable instructions from the non-transitory computer readable medium 1104. The processor(s) 1102 and the non-transitory computer readable medium 1104 may be implemented, for example, in an access management system, such as the access management system 102 (as has been described in conjunction with the preceding figures).

The non-transitory computer readable medium 1104 may be, for example, an internal memory device or an external memory device. In an example implementation, the communication link 1106 may be a network communication link. The processor(s) 1102 and the non-transitory computer readable medium 1104 may also be communicatively coupled to a computing device 1108 over the network.

In an example implementation, the non-transitory computer readable medium 1104 includes a set of computer readable instructions 1110 (referred to as instructions 1110) which may be accessed by the processor(s) 1102 through the communication link 1106. Referring to FIG. 11, in an example, the non-transitory computer readable medium 1104 includes instructions 1110 that cause the processor(s) 1102 to receive a token request. The token request may be received from a communication device over a first communication network. In one example, the token request may be generated in response to processing a machine-readable code. The machine-readable code may be presented on an interface associated with a proprietary system, such as the navigational system 210, as explained in FIGS. 2-5. The machine-readable code is presented pursuant to an access request. In one example, the access request is detected when a user initiates access a proprietary database, such as a navigation database 206 associated with the navigational system 210.

Thereafter, the instructions 1110 cause the processor(s) 1102 to generate a unique token, in response to the token request. In one example, the unique token may correspond to the token request received from the user initiating the access to the navigation database 206. The unique token may be a series of numbers, letters, or an alphanumeric code, and is unique in respect to each token request.

Once the unique token is generated, the instructions 1110 causes the processor(s) 1102 to transmit the unique token to a terminal, over a communication network, such as the communication network 216 as explained in FIG. 2. Once the unique token is transmitted, it may enable access to the navigation database 206, when entered on an interface, such as the interface 212 associated with the navigational system 210. Further, once the unique token is entered on the interface, instructions 116 may be executed to record an access attempt for the user.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a non-transitory machine-readable storage medium storing instructions that, when executed by the processor, cause the system to:
detect, by a physical communication interface, an access request to an aircraft navigation system initiated through a connection between an intermediary access device and the navigation system;
cause the navigational system to display, on a navigation user interface, a machine-readable code that encodes an access-session identifier associated with the detected access request;
receive, over a communication network and from a terminal device that has optically scanned the displayed machine-readable code, a token request corresponding to the access-session identifier;
generate, using the access-session identifier, a time limited unique authentication token bound to the detected access request;
transmit the unique authentication token to the terminal device for manual entry on the navigational user interface of the navigational system;
validate that the unique authentication token entered on the navigational user interface to selectively enable access to a proprietary database stored in the navigational system; and
store, in an access attempt data structure maintained by the system, a recorded access attempt associated with the access-session identifier, wherein the recorded access attempt is used to control subsequent access to the navigation database.

2. The system as claimed in claim 1, wherein the proprietary database is a navigation database.

3. The system as claimed in claim 2, wherein the system is to:
determine a count associated with the recorded access attempt for the user, wherein the count is indicative of a number of attempts attempted by the user to access the navigation database;
compare the count with a pre-defined threshold limit; and
based on the count being less than the pre-defined threshold limit, generate the unique authentication token.

4. The system as claimed in claim 3, when determined that the count is greater than the pre-defined threshold limit is to:
trigger an error notification on the interface, wherein the error notification corresponds to an indication that the user has exceeded an allowed number of access attempts.

5. The system as claimed in claim 1, wherein the machine-readable code is processed by the terminal device associated with the user, and based on the processing, the system is to receive the token request.

6. The system as claimed in claim 2, wherein the terminal device is a portable device associated with the user and acts as an intermediary for establishing communication between the system and the navigation database.

7. The system as claimed in claim 6, wherein the terminal device is to establish communication with the navigation database using one of a USB connection, and an ethernet connection.

8. The system as claimed in claim 2, wherein the navigation database comprises terrain data, navigation aids, flight procedures, arrival and departure data, latitudinal and longitudinal constraints data, and routes data, and combinations thereof.

9. A method comprising:
detecting, by a physical communication interface, an access request to an aircraft navigation system initiated through a connection between an intermediary access device and the navigation system;
causing the navigational system to display, on a navigation user interface, a machine-readable code that encodes an access-session identifier associated with the detected access request;
receiving, over a communication network and from a terminal device that has optically scanned the displayed machine-readable code, a token request corresponding to the access-session identifier;
generating, using the access-session identifier, a time limited unique authentication token bound to the detected access request;
transmitting the unique authentication token to the terminal device for manual entry on the navigational user interface of the navigational system;
validating that the unique authentication token entered on the navigational user interface to selectively enable access to a proprietary database stored in the navigational system; and
storing, in an access attempt data structure maintained by the system, a recorded access attempt associated with the access-session identifier, wherein the recorded access attempt is used to control subsequent access to the navigation database.

10. The method as claimed in claim 9, wherein the proprietary database is a navigation database.

11. The method as claimed in claim 10, further comprising:
validating, by the navigational system, that the unique_authentication token entered by the user, on the interface corresponds to the generated machine-readable code; and based on successful validation of the unique authentication token, allowing, by the navigational system, access to the navigation database.

12. The method as claimed in claim 10, wherein the navigation database comprises one of a terrain data, a navigational aid data, flight procedure data, arrival of flight data, departure of flight data, latitudinal and longitudinal constraints data, routes data, and combinations thereof.

13. The method as claimed in claim 10, wherein the machine-readable code is a quick-response code generated by the navigational system in response to the access request by the user.

14. The method as claimed in claim 9, wherein the unique authentication token is valid for a pre-defined time period.

15. A non-transitory computer-readable medium comprising instructions, the instructions being executable by a processing resource to:
detect, by a physical communication interface, an access request to an aircraft navigation system initiated through a connection between an intermediary access device and the navigation system;
cause the navigational system to display, on a navigation user interface, a machine-readable code that encodes an access-session identifier associated with the detected access request;
receive, over a communication network and from a terminal device that has optically scanned the displayed machine-readable code, a token request corresponding to the access-session identifier:
generate, using the access-session identifier, a time limited unique authentication token bound to the detected access request;
transmit the unique authentication token to the terminal device for manual entry on the navigational user interface of the navigational system;
validate that the unique authentication token entered on the navigational user interface to selectively enable access to a proprietary database stored in the navigational system; and
store, in an access attempt data structure maintained by the system, a recorded access attempt associated with the access-session identifier, wherein the recorded access attempt is used to control subsequent access to the navigation database.

16. The non-transitory computer-readable medium as claimed in claim 15, wherein the proprietary system is a navigational system, and the proprietary database is a navigation database.

17. The non-transitory computer-readable medium as claimed in claim 16, wherein the system is to:
determine a count associated with the recorded access attempt for the user, wherein the count is indicative of a number of attempts attempted by the user to access the navigation database;
compare the count with a pre-defined threshold limit; and
based on the count being less than the pre-defined threshold limit, generate the unique authentication token.

18. The non-transitory computer-readable medium as claimed in claim 17, when determined that the count is greater than the pre-defined threshold limit is to:
trigger an error notification on the interface, wherein the error notification corresponds to an indication that the user has exceeded an allowed number of access attempts.

19. The non-transitory computer-readable medium as claimed in claim 15, wherein the machine-readable code is processed by the terminal device associated with the user, and based on the processing, the system is to receive the token request.

20. The non-transitory computer-readable medium as claimed in claim 15, wherein the terminal device is a portable device associated with the user and acts as an intermediary for establishing communication between the system and the proprietary database.
